(19) United States
(12) Patent Application Publication
(10) Pub. No.: US 2025/0082093 A1
(43) Pub. Date: Mar. 13, 2025

(54) ELECTRICALLY DRIVEN TOOTHBRUSH

(71) Applicant: HAYCO MANUFACTURING LTD., HONG KONG (CN)

(72) Inventor: KIN WONG YAU, HONG KONG (CN)

(21) Appl. No.: 18/816,576

(22) Filed: Aug. 27, 2024

Related U.S. Application Data
(60) Provisional application No. 63/581,068, filed on Sep. 7, 2023.

(51) Int. Cl. A46B 13/02; A46B 5/00; A46B 9/04; A46B 13/00; A61C 17/34

(52) U.S. Cl. CPC A46B 13/02; A46B 5/0058; A46B 5/0095; A46B 9/04; A46B 13/008; A61C 17/34; A61C 2204/002

(57) ABSTRACT

A noise-reduced and quietly operable electrically driven toothbrush with a technically simple basic structure includes a handle portion at a first end of the toothbrush and a head portion at a second end of the toothbrush. The head portion is detachably connectable to the handle portion. A rotatable drive shaft extends at least in the head portion and defines a first longitudinal axis. An electric drive unit directly or indirectly rotates the drive shaft. A bristle holder is pivotally mounted to the head portion and is drivingly engaged by an end of the drive shaft.

### CROSS-REFERENCE TO RELATED APPLICATION

This application claims the benefit, under 35 U.S.C. § 119 (e), of U.S. Provisional Patent Application No. 63/581,068, filed Sep. 7, 2023; the prior application is herewith incorporated by reference in its entirety.

### FIELD AND BACKGROUND OF THE INVENTION

The invention relates to an electrically driven toothbrush, more particularly to an electrically driven toothbrush in which brush bristles are disposed to be moved relative to the toothbrush handle.

There are many examples of such electrically driven toothbrushes, for example an oscillating rotating toothbrush. That type of toothbrush is not shaped like a conventional manual toothbrush. Instead, it is made of a small round brush or bristle head that oscillates and rotates to remove plaque. The shape of the bristle head is very similar to the prophylaxis hand piece used by dental professionals to remove plaque in the dental office. That configuration enables the bristles to reach further into the hard-to-reach areas between the teeth to remove plaque.

One disadvantage of such oscillating rotating electrically driven toothbrushes, however, is that they have a relatively large number of interacting moving components that are subject to manufacturing tolerances. Those tolerances in turn lead to a rattling or noise development during operation of the toothbrushes, which is regularly perceived as unpleasant by the operator.

### SUMMARY OF THE INVENTION

It is accordingly an object of the invention to provide an electrically driven toothbrush, which overcomes the hereinafore-mentioned disadvantages of the heretofore-known devices of this general type, and which is quiet and noise-reduced during operation.

With the foregoing and other objects in view there is provided, in

accordance with the invention, an electrically driven toothbrush comprising at least:
a handle portion, preferably at a first end of the toothbrush,
a head portion, preferably at a second end of the toothbrush, wherein the head portion is detachably connectable to the handle portion,
a rotatable drive shaft extending at least in the head portion and providing a first longitudinal axis,
an electric drive unit through which the drive shaft is directly or indirectly rotatable, and
a bristle holder being pivotally mounted to the head portion and being drivingly engaged by an end of the drive shaft.

This basic structure makes it possible in a technically simple and advantageous manner to form a noise-reduced and quietly operable electric toothbrush, whereby it is further particularly advantageous in this context if the bristle holder is pivotally mounted to the head portion on an axle pin providing a second longitudinal axis in the form of a rotational pivot axis for the bristle holder. According to another preferred embodiment the axle pin projects with its free end from an axle pin bearing pedestal of the head portion and into a pin receiving opening of the bristle holder, preferably with a defined clearance to allow a pivotal movement of the bristle holder around the axle pin.

According to a particularly preferred embodiment at least one elastic biasing element is provided, which, preferably for avoiding rattling, elastically biases the bristle holder in the direction away from the head portion. This helps to achieve a zero or nearly zero clearance in the area of the bristle holder, which in turn leads to the desired noise reduction. In this context, it is particularly advantageous if the at least one elastic biasing element is disposed between the bristle holder and the axle pin bearing pedestal.

In principle, the support can also be provided indirectly via intermediate components. However, it is particularly advantageous if the at least one elastic biasing element is supported on the one hand directly on the axle pin bearing pedestal and on the other hand directly on the bristle holder. Especially if the at least one elastic biasing element is supported on the one hand on a support surface of the axle pin bearing pedestal facing the bristle holder and on the other hand on a support surface of the bristle holder facing the axle pin bearing pedestal.

And in this context, for a particularly functionally reliable and technically easy-to-implement configuration, it is especially advantageous when the support surface of the axle pin bearing pedestal and the support surface of the bristle holder are each flat surfaces facing each other and having a gap distance between them in which the at least one elastic biasing element is disposed.

A high-quality and functionally integrated solution further provides that the axle pin protrudes from the support surface of the axle pin bearing pedestal, with the pin receiving opening being part of the support surface of the bristle holder.

For a particularly compact and robust configuration, it is advantageous that the bristle holder has a wall element surrounding the axle pin at least partially and at a distance, wherein the wall element forms an aperture in which, in the mounted state of the toothbrush, the axle pin bearing pedestal is received at least a partially in a pivotable or rotatable manner, preferably is also received in a contour-adapted and substantially play-free manner.

In principle, there are various possibilities for specifically arranging and structurally implementing the elastic biasing element. According to a particularly preferred cost-effective and extremely reliable technical solution, it is proposed that the at least one elastic biasing element is ring-shaped and disposed around the axle pin, preferably formed by at least one O-ring of an elastic material or by at least one spring washer, whereby the arrangement of a spring washer, which is preferably formed from spring steel, is particularly advantageous in this respect, as it is very wear-free.

According to a particularly preferred specific embodiment, it may also be provided that the wall element of the bristle holder forms a ring-shaped aperture in which the axle pin bearing pedestal, which has a ring-shaped outer geometry, is accommodated at least a partially in a contour-adapted and substantially play-free manner. And with this it is further preferred that between the support surface of the axle pin bearing pedestal and the support surface of the bristle holder on the one hand and a wall section of the wall element on the other hand a ring-shaped receiving space is formed around the axle pin, in which receiving space the at least one ring-shaped elastic biasing element is received and elastically biases the bristle holder in the direction away from the axle pin bearing pedestal.

In order to ensure replaceability, it is also desirable that the bristle holder is formed by a separate component which is detachably connected to the head portion and pivotably connected relative to the head portion. And in this context, it is further preferred that at least one mounting element is provided through the use of which the bristle holder is detachably held on the head portion so as to be pivotable relative to the head portion.

A technically simple solution for this can provide that the at least one mounting element is formed by a lock pin which, in its mounted state, secures the bristle holder against lifting off in the direction of the rotational pivot axis and thus also against lifting off in the direction of the prestressing force applied by the at least one elastic biasing element. Especially in combination with such a lock pin, the use of the at least one elastic biasing element is particularly advantageous because it allows to achieve a zero clearance between the bristle holder and the lock pin, which in turn leads to the desired noise reduction.

For an easily controllable and functionally reliable technical solution, it is also advantageous that the lock pin in the mounted state is held in the head portion and is aligned substantially perpendicular to the rotational pivot axis, wherein it engages with a free lock pin end in a slot recess of the bristle holder which is aligned horizontally with respect to the rotational pivot axis and in which the lock pin is held in the direction of the rotational pivot axis in a form-fitting and/or contour-fitting manner and in which the lock pin is displaceable in the horizontal direction within adjustment ranges which are predetermined by the slot geometry.

Depending on the structural variant, it can be provided that the axle pin is integrally formed with the axle pin bearing pedestal or that the axle pin is retained, preferably releasably retained, with a pedestal side end in an axle pin receiving opening of the axle pin bearing pedestal. This increases the flexibility in configuration.

It is preferred that the electric drive unit is formed by an electric motor. An electric motor can be specifically configured to produce the desired movements, and it operates on electrical power provided by at least one battery or at least one rechargeable battery within the handle portion.

In connection with the toothbrush according to the invention, it is particularly advantageous that the bristle head makes a rotational/oscillatory movement. This can be achieved in a particularly simple manner, for example, in that the bristle-holder side end of the drive shaft being a remote-most end of the drive shaft, with the remote-most end of the drive shaft being bent in a hook like manner, preferably being bent towards an intersection of the first longitudinal axis and the rotational pivot axis. Furthermore, the bristle holder has a closed-ended slot extending radially inward from the outer circumference of the bristle holder to less than the distance to the center of the bristle holder to receive and retain the remote-most end of the drive shaft.

And further, it is beneficial for effective tooth brushing if:
the bristle holder has a top surface on the side opposite the axle pin, the top surface having a plurality of bristle receiving and retaining holes distributed over the top surface and spaced apart, and/or
the bristle holder has a substantially circular outer geometry.

According to a further particularly advantageous structure which can be realized in a technically simple and functionally reliable manner and which can be used to reduce noise during operation of the toothbrush both independently and in combination with the above-described variant according to the invention (i.e., the elastic biasing of the bristle holder), it is provided:
that the rotatable drive shaft runs inside the head portion, preferably with the head portion being at least partially hollow and/or sleeve-like on the inside,
that the drive shaft is rotatably mounted in a shaft bearing, the shaft bearing being formed or disposed in the interior of the head portion, preferably in a section of the head portion facing the bristle holder,
that the drive shaft extends through and away from the shaft bearing in the direction of the handle portion, and
that at least one elastic prestress element is provided which elastically prestresses the drive shaft, preferably in the direction away from the shaft bearing.

In this way it is possible to achieve a zero or nearly zero clearance in the area of the drive shaft in a technically simple and functionally reliable way and thus a noise reduction, especially if the drive shaft is coupled with a coupling element, as will be explained below.

It is understood that the two above-referenced biasing/prestress solutions for the bristle holder and the drive shaft can be used both individually and together in a toothbrush. However, the use of both biasing/prestress solutions has the advantage that the two solutions complement each other and interact with each other in such a way that a particularly advantageous and rattle-free structure with zero or nearly zero clearance can be achieved, resulting in a particularly high-quality toothbrush that is extremely quiet in operation.

Here, too, there are several possibilities to concretely configure the shaft bearing. For example, it can be provided that the shaft bearing is an integral part of the head portion or that the shaft bearing is formed by a separate component which is supported and accommodated inside the head portion.

For an easy to manufacture and functionally reliable construction, it can furthermore be provided here that the at least one elastic prestress element is supported on the shaft bearing, on the one hand, and in that the drive shaft has a support element in a drive shaft part spaced apart from the shaft bearing in the direction of the handle portion, on which support element the at least one elastic prestress element is also supported in order to elastically prestress the drive shaft, preferably in the direction away from the shaft bearing.

Technically particularly reliable and simple to manufacture is a structure in which the support element is formed by a shaft-side thickening.

For a compact and small construction, it is advantageous if the at least one elastic prestress element encloses the shaft section between the shaft bearing and the support element, with the elastic prestress element being preferably formed by a functionally reliable and inexpensive coil spring.

A simple and functionally reliable actuation of the drive shaft is achieved with an embodiment in which it is provided that the drive shaft extends in the direction of the handle portion with a drive shaft end opposite the bristle holder, with the drive shaft end being rotatable coupled directly or indirectly to an actuator element of the electric drive unit, preferably with the actuator element being a motor output shaft of an electric motor as the electric drive unit. And in this context, it is particularly preferred if the drive shaft end is rotationally connected by using a coupling element with a free end of the motor output shaft, preferably in such a way that the drive shaft together with the coupling element and the motor output shaft form a common rotatable drive shaft and a first longitudinal axis.

A compact and small construction, with a high degree of functional safety at the same time, is achieved with a construction in which it is provided that the coupling element is formed by a sleeve element with a substantially cylindrical outer contour, the sleeve element being aligned in the direction of the first longitudinal axis, wherein at or in the sleeve opening end sections of the sleeve element lying on opposite sides on the one hand the drive shaft end and on the other hand the free end of the motor output shaft are held, preferably detachably held.

According to a further particularly preferred aspect of the invention, it is proposed that the handle portion has an elongate, preferably an elongate and internally at least partially hollow-formed and/or sleeve-like, stem section which extends in the direction of the first longitudinal axis and through the use of which the handle portion is detachably connectable to the head portion, with the head portion having a receiving opening at an end region opposite the bristle holder. Furthermore, in the assembled state, the stem section is inserted with at least a part of its free end into the receiving opening of the head portion and is detachably retained there. This makes it possible to create a connection between the head portion and the handle portion that is both stable and easily detachable in a structurally-appealing and technically simple manner. This applies all the more if, according to a particularly preferred embodiment, it is provided that a quick-lock connection, preferably a snap-fit connection as a quick-lock connection, is provided for the detachable connection between the head portion and the stem section of the handle portion.

In connection with this aspect of the invention, it is also advantageous for a compact and easy-to-manufacture structure if the coupling element is formed and/or disposed in the interior of the stem section, it being preferably provided that the coupling element is formed by a separate component which is held and accommodated in the interior of the stem section.

According to a particularly advantageous and technically simple solution, it can furthermore be specifically provided here that the stem section has a fastening element at its free end facing the head portion, the fastening element interacting with a fastening counter element inside the receiving opening of the head portion in the inserted, assembled state.

According to a particularly advantageous and technically simple solution, it can furthermore be specifically provided that the fastening element is tube-shaped and projects from the free end of the stem section in a pin-like manner. The tube-shaped fastening element has here, on the outer circumferential region, a, preferably annularly, circumferential snap-in area into which, in the assembled state of the snap-fit connection, at least one elastically expandable snap-in element of the fastening counter element snaps and thus detachably holds the free end of the stem section in the receiving opening of the head portion. Furthermore, the at least one elastically expandable snap-in element of the fastening counter element can be elastically pressed over both when making and when releasing the snap-fit connection. A quick-release connection of this kind ensures a particularly high-quality technical connection of the two components, which can also be easily and quickly released.

With such a structure, a compact overall configuration can also be achieved in that the free end of the drive shaft is guided through the tube-shaped fastening element into the interior of the stem section, preferably to the coupling element formed or disposed in the interior of the stem section.

A high quality, rattle-free and compact overall configuration can also be achieved in that a part of the outer, preferably cylindrical, outer circumferential region of the free end of the stem section is received in the assembled state in a form-fitting and/or contour-fitting manner and/or substantially without play in the interior of the head portion.

The fastening counter element may be also part of a retainer sleeve disposed and held inside the head portion, which supports in a double function a drive shaft bearing and holds it in position.

Furthermore, it is preferred if the stem section has at least one compartment for accommodating components of the toothbrush, preferably in such a way that the electric drive unit and/or at least one battery (rechargeable or not) is accommodated in a drive unit compartment in the interior of the handle portion.

Other features which are considered as characteristic for the invention are set forth in the appended claims.

Although the invention is illustrated and described herein as embodied in an electrically driven toothbrush, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1a is a diagrammatic, exemplary perspective view of an electrically driven toothbrush according to the invention;

FIG. 1b is another exemplary perspective view of an electrically driven toothbrush according to the invention;

FIG. 2 is a diagrammatic, longitudinal-sectional view through the electrically driven toothbrush shown in FIG. 1;

FIG. 3 is an enlarged view of the head portion with the bristle holder in an extended perspective view;

FIG. 4 is an enlarged sectional view through the bristle holder;

FIG. 5 is an enlarged view of the head portion with the drive shaft in an extended perspective view;

FIG. 6 is a view according to FIG. 5 in the assembled state of the drive shaft with the housing of the head portion partially open;

FIG. 7 is a first detailed view of the snap-fit connection between the head portion and the handle portion; and

FIG. 8 is a second detailed view of the snap-fit connection between the head portion and the handle portion.

### DETAILED DESCRIPTION OF THE INVENTION

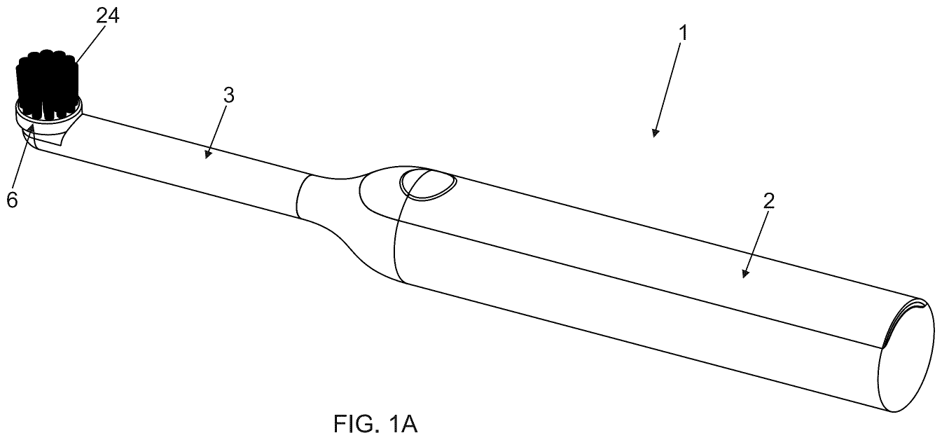

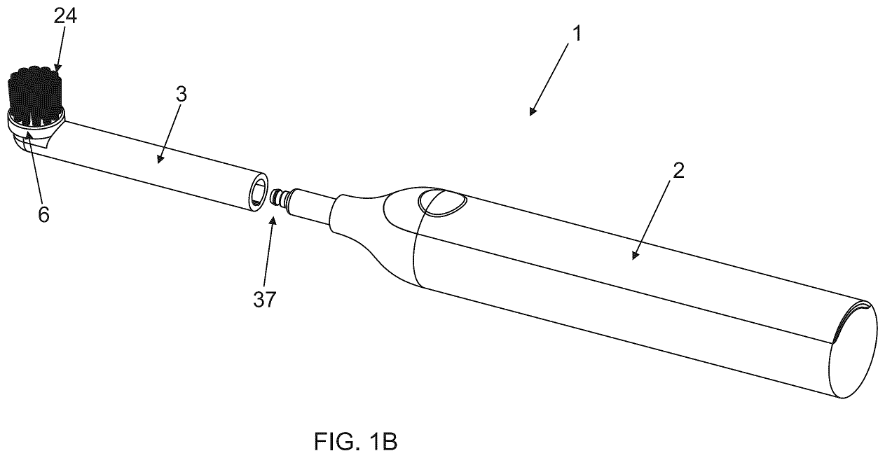

Referring now to the figures of the drawings in detail and first, particularly, to FIGS. 1a and 1b thereof, there is seen a diagrammatic and perspective view of an exemplary embodiment of an electrically driven toothbrush 1 according to the invention, which has a handle portion 2 and a head portion 3.

The handle portion 2 forms a first end of the toothbrush 1, while the head portion 3 forms a second end of the toothbrush 1. The handle portion 2 and the head portion 3 are detachably connected to each other in a manner described in more detail below.

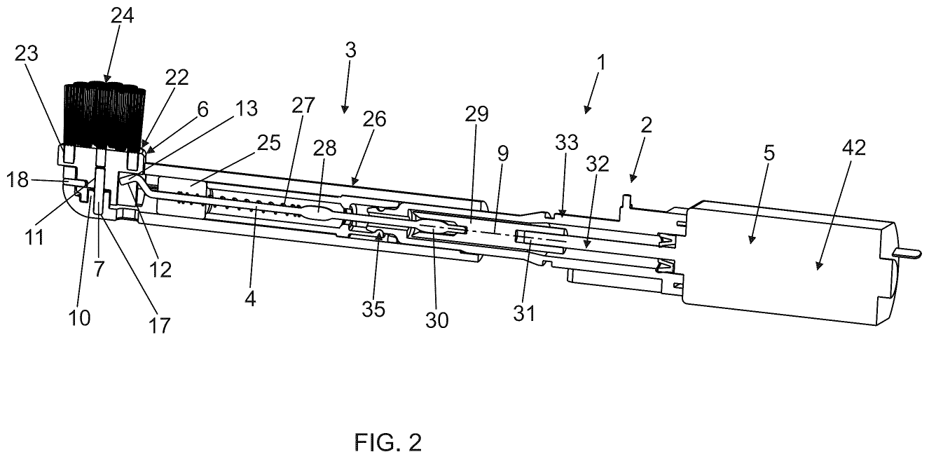

As can be seen in particular from FIG. 2, which shows a longitudinal section through the structure of FIG. 1a or 1b, the toothbrush 1 has a rotatable drive shaft 4, which is part of a first longitudinal axis 9 or forms the first longitudinal axis 9 and which is rotatably driven by an electric motor 5 as a preferred example of an electric drive unit, in a manner also described in more detail below.

In addition, the toothbrush 1 includes a bristle holder 6, which is pivotably disposed on the head portion 3 for an oscillating/rotating movement and can be driven by the drive shaft 4 in a manner to be described.

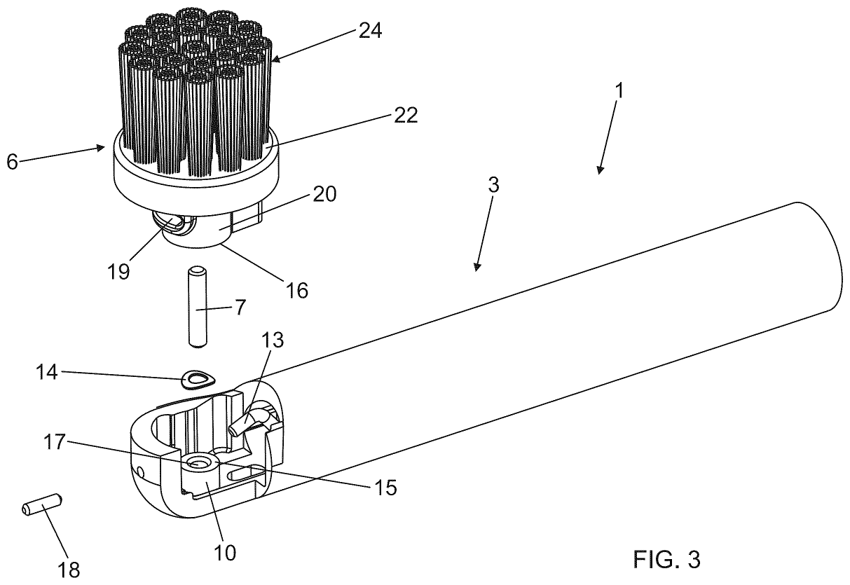

As can be seen from FIGS. 2, 3 and 4, the bristle holder 6 is pivotally mounted to the head portion 3 on an axle pin 7. This axle pin 7 provides a second longitudinal axis in the form of a rotational pivot axis 8 for the bristle holder 6. As can be further seen from FIGS. 2, 3 and 4, the axle pin 7 projects with its free end from an axle pin bearing pedestal 10 of the head portion 3 and into a pin receiving opening 11 of the bristle holder 6, preferably with a defined clearance to allow a pivotal movement of the bristle holder 6 around the axle pin 7 for the desired oscillating/rotating movement of the bristle holder 6.

In order to enable the oscillating/rotating movement of the bristle holder 6, the remote-most end 13 of the drive shaft 4 is bent in a hook like manner, namely bent towards an intersection of the first longitudinal axis 9 and the rotational pivot axis 8, with the bristle holder 6 having a closed-ended slot 12 extending radially inward from the outer circumference of the bristle holder 6 to less than the distance to the center of the bristle holder 6 to receive and retrain the remote-most end 13 of the drive shaft 4.

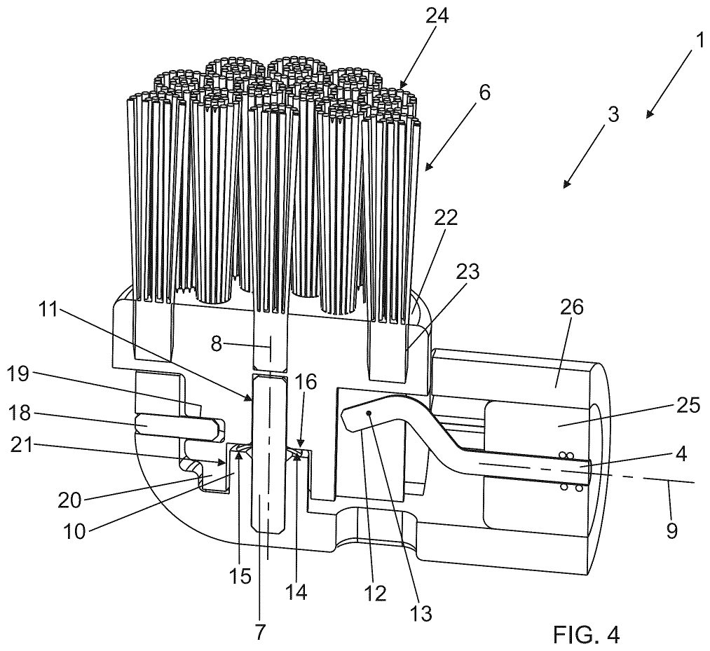

As can be seen in particular from FIG. 4, a spring washer is provided as a preferred example of an elastic biasing element 14 which elastically biases the bristle holder 6, in the direction away from the head portion 3, which will now be explained in more detail below:

As can be clearly seen in FIG. 4, the spring washer 14 is supported on one side on a support surface 15 of the axle pin bearing pedestal 10 facing the bristle holder 6 and on the other side on a support surface 16 of the bristle holder 6 facing the axle pin bearing pedestal 10. This means that the spring washer 14 is supported directly on the axle pin pedestal 10 on the one hand and directly on the bristle holder 6 on the other hand and is accordingly disposed between the bristle holder 6 and the axle pin bearing pedestal 10. The support surface 15 of the axle pin bearing pedestal 10 and the support surface 16 of the bristle holder 6 are preferably flat surfaces facing each other and having a gap distance between them in which the spring washer 14 is disposed.

In the embodiment shown herein, the axle pin 7 is formed by a separate component that is held with a pedestal side end in an axle pin receiving opening 17 of the axle pin bearing pedestal 10, preferably in a detachable manner. Likewise, the axle pin 7 could alternatively be integrally formed with the axle pin bearing pedestal 10, but this is not shown herein.

The fixed connection and holding of the axle pin 7 to or in the axle pin bearing pedestal 10 is the preferred solution, because the possibly desired play for the pivotal movement of the bristle holder 6 can then be adjusted very easily via the pin receiving opening 11 of the bristle holder 6. In principle, however, and expressly covered by the scope of protection, are kinematic inversions in which the axle pin 7 projects from the support surface of the bristle holder 6 and the pin receiving opening is part of the support surface 15 of the axle pin bearing pedestal 10, i.e. the axle pin 7 is either integrally formed with the bristle holder 6 or the axle pin 7 is held, preferably releasably, in an axle pin receiving opening of the bristle holder. However, this kinematic inversion is not shown herein.

In the present example, the bristle holder 6 is formed by a separate component that is detachably connected to the head portion 3 and can be pivoted relative to the head portion 3. For this purpose, a lock pin 18 is provided as a mounting element which, in its mounted state, is held in the head portion 3 and is aligned substantially perpendicular to the rotational pivot axis 8. It engages with a free lock pin end in a slot recess 19 of the bristle holder 6 that is horizontally aligned with respect to the rotational pivot axis 9, in which the lock pin 18 is held in the direction of the rotational pivot axis 9 in a form-fitting and/or contour-fitting manner and in which the lock pin 18 is displaceable in the horizontal direction within adjustment ranges that are predetermined by the slot geometry. Thus, in its mounted state, the lock pin 18 secures the bristle holder 6 against lifting in the direction of the rotational pivot axis 9 and thus also against lifting in the direction of the biasing force applied by the spring washer 14. This helps to achieve a zero or nearly zero clearance in the area of the bristle holder 6, which in turn leads to the desired noise reduction.

As can be seen in particular from FIG. 4, the bristle holder 6 also has a wall element 20 which surrounds the axle pin 7 in the assembled state at least in certain areas and at a distance, the wall element forming an aperture 21 in which the axle pin bearing pedestal 10 is received at least partially pivotably or rotatably, preferably is also received in a contour-adapted and substantially play-free manner. As is the case in the example shown herein, the wall element 20 of the bristle holder 6 forms a ring-shaped aperture 21 in which the axle pin bearing pedestal 10 having a ring-shaped outer geometry is received in a contour-adapted and substantially play-free manner, so that between the support surface 15 of the axle pin bearing pedestal 10 and the support surface 16 of the bristle holder 6, on the one hand, and a wall section of the wall element 20, on the other hand, a ring-shaped receiving space is formed which runs around the axle pin 7 and in which the spring washer 14 is received, which elastically biases the bristle holder 6 in the direction away from the axle pin bearing pedestal 10.

As can be seen further, the bristle holder 6 herein has an exemplary substantially circular outer geometry.

In addition, the bristle holder 6 (see in particular FIG. 4) has a top surface 22 on the side opposite the axle pin 7, which has a plurality of bristle receiving and retaining holes 23 distributed over the top surface 22 and spaced apart, in which bristles 24 are inserted and retained.

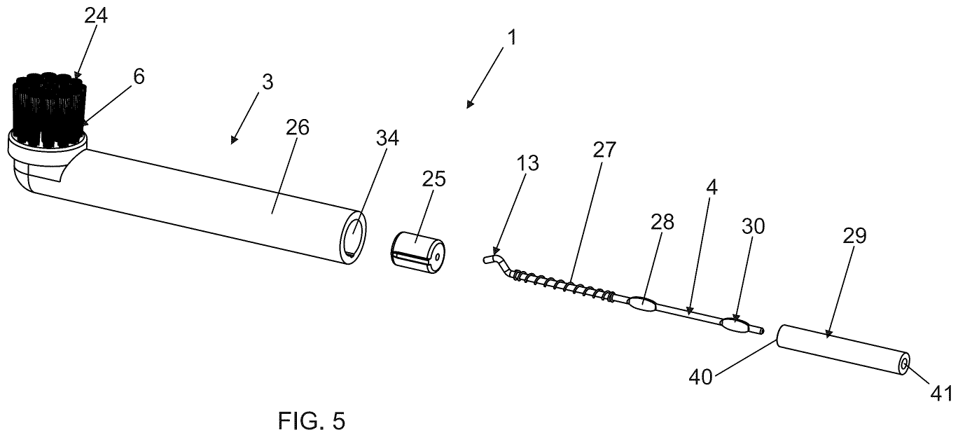

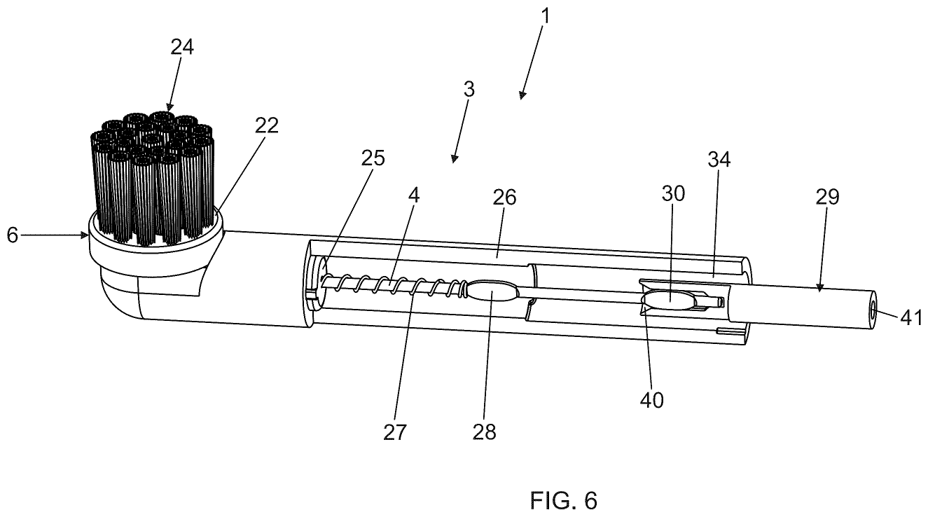

As can now be seen in particular from FIGS. 2, 5 and 6, the rotatable drive shaft 4 runs inside the hollow or sleeve-like head portion 3.

Further, the drive shaft 4 is supported in a shaft bearing 25, wherein the shaft bearing 25 is disposed inside a housing 26 of the head portion 6, in a section of the head portion 3 facing the bristle holder 6. The shaft bearing 25 is formed herein by a separate component which is held and accommodated inside the housing 26 of the head portion 3.

As can be seen, the drive shaft 24 extends through and away from the shaft bearing 25 in the direction of the handle portion 2, whereby an elastic prestress element 27 in the form of a coil spring is provided. This coil spring 27 elastically biases/prestresses the drive shaft 24, preferably in the direction away from the shaft bearing 25. Specifically, the coil spring 27 is supported on the one hand on the shaft bearing 25 and on the other hand on a support element configured herein as a thickening 28, which is spaced from the shaft bearing 25 in the direction of the handle portion 2. The coil spring 27 clearly encloses the shaft section between the shaft bearing 25 and the thickening 28.

In this way, it is possible to achieve a zero or nearly zero clearance in the area of the drive shaft 4 in a technically simple and functionally reliable way and thus a noise reduction, especially if the drive shaft 4 is coupled with a coupling element 29, as will be explained below.

It is understood that the two above-referenced biasing/prestress solutions for the bristle holder and the drive shaft can be used both individually and together in a toothbrush. However, the use of both biasing/prestress solutions as in the present preferred example has the advantage that the two solutions complement each other and interact with each other in such a way that a particularly advantageous and rattle-free structure with zero or nearly zero clearance can be achieved, resulting in a particularly high-quality toothbrush that is extremely quiet in operation.

As can be seen in particular from FIG. 2, a drive shaft end 30, which is only thickened by way of example herein, is drivingly engaged, respectively rotatably coupled, by the coupling element 29 with a free end 31 of a motor output shaft 32 of the electric motor 5. Thus, in the embodiment shown, the drive shaft 4 together with the coupling element 29 and the motor output shaft 32 form a common rotatable drive shaft and a common first longitudinal axis.

It is evident that the coupling element 29 is formed by a sleeve element with a substantially cylindrical outer contour, the sleeve element being aligned in the direction of the first longitudinal axis 9, the drive shaft end 30 on the one hand and the free end 31 of the motor output shaft 32 on the other hand being held, and preferably releasably held, on or in the sleeve opening end sections 40, 41 of the sleeve element lying on opposite sides.

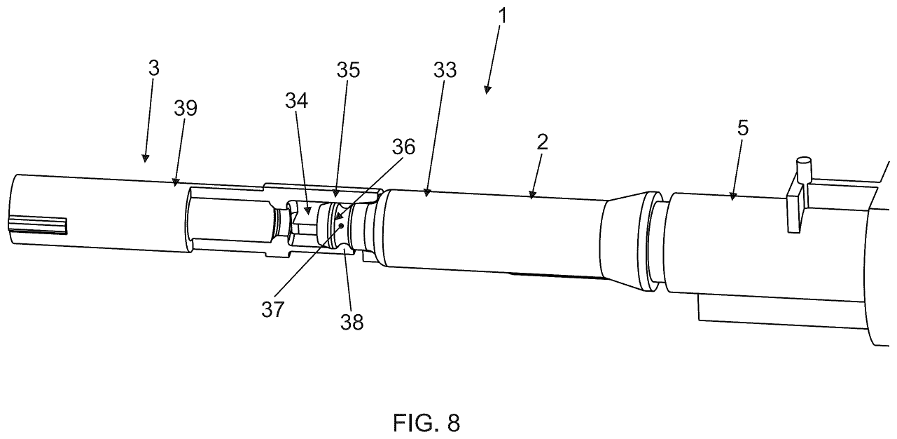

As can be seen from FIGS. 2, 7 and 8, but in particular from FIG. 2, the handle portion 2 has an elongated stem section 33 which is hollow or sleeve-like on the inside, extends in the direction of the first longitudinal axis 9 and through the use of which the handle portion 2 can be detachably connected to the head portion 3. For this purpose, the head portion 3 has a receiving opening 34 at an end region opposite the bristle holder 6, so that the stem section 33, in the assembled state, is inserted with part of its free end into the receiving opening 34 of the head portion 3 and is detachably held there.

As can be further seen from FIGS. 2, 7 and 8, the coupling element 29 is disposed within the hollow-formed housing of the stem section 33 and is formed by a separate component which is supported and received within the interior of the stem section 33.

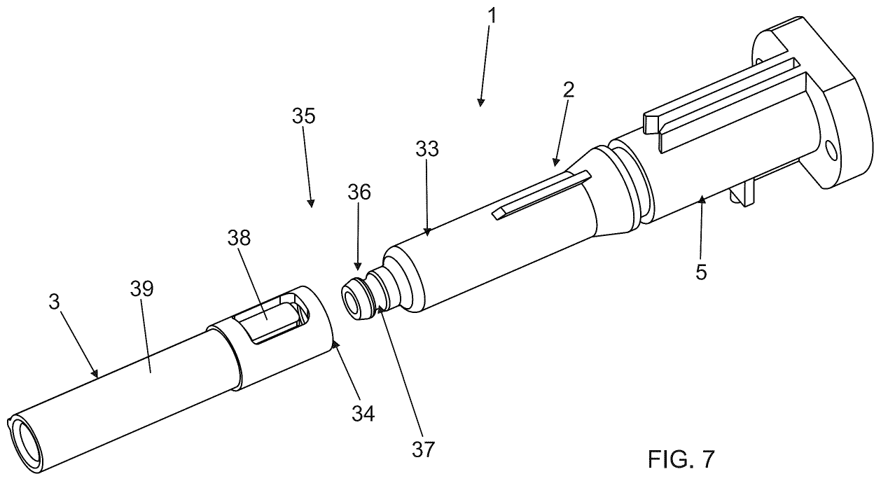

For the detachable connection between the head portion 3 and the stem section 33 of the handle portion 2, a snap-fit connection 35 is provided as a quick-lock connection. In order to form the snap-fit connection 35, the stem section 33 has a fastening element 36 at its free end facing the head portion 3, which is tube-shaped and projects from the free end of the stem section 33 in a pin-like manner. The tube-shaped fastening element 36 has on the outer circumferential area a snap-in area 37, herein exemplarily annularly circumferential, into which, in the assembled state of the snap-fit connection 35, at least one elastically expandable snap-in element snaps as a fastening counter element 38, which is disposed inside the receiving opening 34 of the head portion 3, and thus holds the free end of the stem section 33 releasably in the receiving opening 34 of the head portion 3. One of the preferably several snap-in elements 38 is readily apparent in FIG. 7. In particular, it is readily apparent herein that the at least one snap-in element 38 is in the form of an elastically articulated snap-in finger.

It is understood that the at least one elastically expandable snap-in element 38 can be elastically pressed-over, both when making and when releasing the snap-fit connection 35 if a corresponding force threshold is exceeded. The advantage of such a snap-fit connection 35 is thus that the at least one snap-in element 38 is not only elastically deflectable, but also elastically springs back again after each deflection.

Further, it can be seen that the snap-in element 38 is part of a retainer sleeve 39 disposed and retained inside the head portion 3, which supports the shaft bearing 25 and holds it in position in the head portion 3.

As can be seen in FIG. 2, the free end of the drive shaft 4, i.e. the drive shaft end 30, is guided through the tube-shaped fastening element 36 into the interior of the stem section 33, to the coupling element 29 disposed inside the stem section 33.

As can be seen further, part of the outer, preferably cylindrical, circumferential area of the free end of the stem section 33 in the assembled state is form-fitted and contour-fitted and preferably also received substantially free of play in the interior of the head portion 3.

In addition, the stem section 33, which is only extremely diagrammatically shown, has at least one compartment for accommodating components of the toothbrush 1, for example a compartment 42 for accommodating the electric motor 5 and a rechargeable battery which is not shown herein.

The following is a summary list of reference numerals and the corresponding structure used in the above description of the invention:
1 toothbrush
2 handle portion
3 head portion
4 drive shaft
5 electric motor
6 bristle holder
7 axle pin
8 pivot axis
9 first longitudinal axis
10 axle pin bearing pedestal
11 pin receiving opening
12 slot
13 remote-most end
14 elastic biasing element/spring washer
15 support surface
16 support surface
17 axle pin receiving opening
18 mounting element/lock pin
19 slot recess
20 wall element
21 aperture
22 top surface
23 holes
24 bristles
25 shaft bearing
26 housing
27 elastic prestress element/coil spring
28 support element/thickening
29 coupling element
30 drive shaft end
31 free end
32 motor output shaft
33 stem section
34 receiving opening
35 snap-fit connection
36 fastening element
37 snap-in area
38 fastening counter element/snap-in element
39 retainer sleeve
40 sleeve opening end section
41 sleeve opening end section
42 compartment

1. An electrically driven toothbrush, comprising:
a handle portion;
a head portion detachably connectable to said handle portion;
a drive shaft being rotatable and extending at least in said head portion, said drive shaft defining a first longitudinal axis and having an end;
an electric drive unit directly or indirectly rotating said drive shaft; and
a bristle holder pivotally mounted to said head portion and drivingly engaged by said end of said drive shaft.

2. The toothbrush according to claim 1, wherein said handle portion is disposed at a first end of the toothbrush, and said head portion is disposed at a second end of the toothbrush.

3. The toothbrush according to claim 1, which further comprises an axle pin defining a second longitudinal axis forming a rotational pivot axis for said bristle holder, said bristle holder being pivotally mounted to said head portion on said axle pin.

4. The toothbrush according to claim 3, wherein said head portion has an axle pin bearing pedestal, said bristle holder has a pin receiving opening, said axle pin has a free end projecting from said axle pin bearing pedestal into said pin receiving opening.

5. The toothbrush according to claim 4, wherein said axle pin has a defined clearance in said pin receiving opening to allow a pivotal movement of said bristle holder around said axle pin.

6. The toothbrush according to claim 4, which further comprises at least one elastic biasing element elastically biasing said bristle holder in a direction away from said head portion for avoiding rattling.

7. The toothbrush according to claim 6, wherein said at least one elastic biasing element is disposed between said bristle holder and said axle pin bearing pedestal.

8. The toothbrush according to claim 6, wherein said at least one elastic biasing element is supported directly on said axle pin bearing pedestal and directly on said bristle holder.

9. The toothbrush according to claim 6, wherein said axle pin bearing pedestal has a support surface facing said bristle holder, said bristle holder has a support surface facing said axle pin bearing pedestal, and said at least one elastic biasing element is supported on said support surfaces.

10. The toothbrush according to claim 9, wherein said support surface of said axle pin bearing pedestal and said support surface of said bristle holder are each flat surfaces facing each other and having a gap distance therebetween in which said at least one elastic biasing element is disposed.

11. The toothbrush according to claim 9, wherein:
said axle pin protrudes from said support surface of said axle pin bearing pedestal; and
said pin receiving opening is part of said support surface of said bristle holder.

12. The toothbrush according to claim 9, wherein said bristle holder has a wall element surrounding said axle pin at least partially and at a distance, and said wall element forms an aperture in which said axle pin bearing pedestal, in a mounted state of the toothbrush, is received at least partially in a pivotable or rotatable manner and in a contour-adapted and substantially play-free manner.

13. The toothbrush according to claim 6, wherein said at least one elastic biasing element is ring-shaped and disposed around said axle pin, or is formed by at least one O-ring of an elastic material or is formed as at least one spring washer.

14. The toothbrush according to claim 12, wherein:
said axle pin bearing pedestal has a ring-shaped outer geometry;
said wall element of said bristle holder forms a ring-shaped aperture in which said axle pin bearing pedestal is accommodated at least partially in a contour-adapted and substantially play-free manner;
a ring-shaped receiving space is formed around said axle pin between said support surfaces of said axle pin bearing pedestal and bristle holder and a wall section of said wall element; and
said at least one ring-shaped elastic biasing element is received in said ring-shaped receiving space and elastically biases said bristle holder in a direction away from said axle pin bearing pedestal.

15. The toothbrush according to claim 1, wherein said bristle holder is formed by a separate component being detachably connected to said head portion and pivotably connected relative to said head portion.

16. The toothbrush according to claim 3, which further comprises at least one mounting element detachably holding said bristle holder on said head portion so as to be pivotable relative to said head portion.

17. The toothbrush according to claim 16, wherein said at least one mounting element is formed by a lock pin securing, in its mounted state, said bristle holder against lifting off in a direction of said rotational pivot axis.

18. The toothbrush according to claim 17, wherein:
said lock pin in said mounted state is held in said head portion and is aligned substantially perpendicular to said rotational pivot axis;
said lock pin has a free lock pin end engaging in a slot recess of said bristle holder being aligned horizontally relative to said rotational pivot axis;
said lock pin is held in said slot recess in the direction of said rotational pivot axis in at least one of a form-fitting or contour-fitting manner; and
said lock pin is displaceable in said slot recess in the horizontal direction within adjustment ranges being predetermined by a geometry of said in slot recess.

19. The toothbrush according to claim 4, wherein said axle pin is integrally formed with said axle pin bearing pedestal or said axle pin is retained or releasably retained with a pedestal side end in an axle pin receiving opening of said axle pin bearing pedestal.

20. The toothbrush according to claim 1, wherein said electric drive unit is formed by an electric motor.

21. The toothbrush according to claim 20, wherein said electric motor is powered by at least one battery or at least one rechargeable battery located in said handle portion.

22. The toothbrush according to claim 3, wherein:
said end of said drive shaft drivingly engaging said bristle holder is a remote-most end of said drive shaft;
said remote-most end of said drive shaft is bent in a hook-shaped manner or is bent in a hook-shaped manner towards an intersection of said first longitudinal axis and said rotational pivot axis;
said bristle holder has a closed-ended slot extending radially inward from an outer circumference of said bristle holder to less than a distance to a center of said bristle holder, for receiving and retaining said remote-most end of said drive shaft.

23. The toothbrush according to claim 3, wherein said bristle holder has a top surface on a side opposite said axle pin, and said top surface has a plurality of bristle receiving and retaining holes distributed over said top surface and mutually spaced apart.

24. The toothbrush according to claim 1, wherein said bristle holder has a substantially circular outer geometry.

25. The toothbrush according to claim 1, wherein:
said rotatable drive shaft runs inside said head portion;
said drive shaft is rotatably mounted in a shaft bearing, said shaft bearing is formed or disposed in an interior of said head portion;
said drive shaft extends through and away from said shaft bearing in a direction of said handle portion; and
at least one elastic prestress element elastically prestresses said drive shaft.

26. The toothbrush according to claim 25, wherein said head portion is at least one of at least partially hollow or sleeve-shaped on an inside, said shaft bearing is formed or disposed in a section of said head portion facing said bristle holder, and said at least one elastic prestress element elastically prestresses said drive shaft in a direction away from said shaft bearing.

27. The toothbrush according to claim 26, wherein said shaft bearing is an integral part of said head portion or said shaft bearing is formed by a separate component supported and accommodated inside said head portion.

28. The toothbrush according to claim 26, wherein:
said at least one elastic prestress element is supported on said shaft bearing;
said drive shaft has a support element in a drive shaft part spaced apart from said shaft bearing in a direction of said handle portion; and
said at least one elastic prestress element is supported on said support element to elastically prestress said drive shaft or to elastically prestress said drive shaft in a direction away from said shaft bearing.

29. The toothbrush according to claim 28, wherein said support element is formed by a shaft-side thickening.

30. The toothbrush according to claim 28, wherein said at least one elastic prestress element, or a coil spring forming said elastic prestress element, encloses a shaft section between said shaft bearing and said support element.

31. The toothbrush according to claim 1, wherein:
said drive shaft has a drive shaft end disposed opposite said bristle holder and extending in a direction of said handle portion;
said electric drive unit has an actuator element or said electric drive unit is an electric motor having a motor output shaft being an actuator element; and
said drive shaft end disposed opposite said bristle holder is rotatably coupled directly or indirectly to said actuator element.

32. The toothbrush according to claim 31, which further comprises a coupling element, said motor output shaft having a free end rotationally connected by said coupling element to said drive shaft end disposed opposite said bristle holder.

33. The toothbrush according to claim 32, wherein said drive shaft together with said coupling element and said motor output shaft form a common rotatable drive shaft and the first longitudinal axis.

34. The toothbrush according to claim 32, wherein:
said coupling element is formed by a sleeve element with a substantially cylindrical outer contour;
said sleeve element is aligned in a direction of said first longitudinal axis;
said sleeve element has sleeve opening end sections lying on opposite sides; and
said drive shaft end and said free end of said motor output shaft are each held or detachably held at or in a respective one of said sleeve opening end sections.

35. The toothbrush according to claim 34, wherein:
said handle portion has a stem section being elongate or elongate and internally at least partially at least one of hollow-formed or sleeve-shaped;
said stem section extends in a direction of the first longitudinal axis for detachably connecting said handle portion to said head portion;
said head portion has a receiving opening at an end region opposite said bristle holder; and
said stem section has a free end being at least partially inserted into and detachably retained at said receiving opening of said head portion in an assembled state.

36. The toothbrush according to claim 35, wherein said coupling element is at least one of formed or disposed in an interior of said stem section, or said coupling element is formed by a separate component held and accommodated in said interior of the stem section.

37. The toothbrush according to claim 36, which further comprises a quick-lock connection or a snap-fit connection acting as a quick-lock connection for detachably connecting said head portion and said stem section of said handle portion.

38. The toothbrush according to claim 37, wherein said stem section has a fastening element at said free end facing said head portion, said fastening element interacting with a fastening counter element inside said receiving opening of said head portion in an inserted, assembled state.

39. The toothbrush according to claim 38, wherein:
said fastening element is tube-shaped and projects from said free end of said stem section in a pin-shaped manner;
said tube-shaped fastening element has an outer circumferential region and an annular or circumferential snap-in area on said outer circumferential region;
at least one elastically expandable snap-in element of said fastening counter element snaps into said annular or circumferential snap-in area and detachably holds said free end of said stem section in said receiving opening of said head portion in an assembled state of said snap-fit connection; and
said at least one elastically expandable snap-in element of said fastening counter element is configured to be elastically pressed over when making and when releasing said snap-fit connection.

40. The toothbrush according to claim 39, wherein said free end of said drive shaft is guided through said tube-shaped fastening element into said interior of said stem section.

41. The toothbrush according to claim 40, wherein said free end of said drive shaft is guided to said coupling element formed or disposed in said interior of said stem section.

42. The toothbrush according to claim 39, wherein said free end of said stem section has an outer or outer cylindrical, outer circumferential region, and part of said outer or outer cylindrical, outer circumferential region is received in at least one of a form-fitting or contour-fitting manner or substantially without play in an interior of said head portion in said assembled state.

43. The toothbrush according to claim 38, which further comprises a drive shaft bearing, said fastening counter element being part of a retainer sleeve disposed and held inside said head portion, for supporting and holding said drive shaft bearing in position.

44. The toothbrush according to claim 35, wherein said stem section has at least one compartment for accommodating components of the toothbrush.

45. The toothbrush according to claim 44, wherein said electric drive unit is accommodated in a drive unit compartment in an interior of said handle portion.
